(19) United States
(12) Patent Application Publication
(10) Pub. No.: US 2008/0025302 A1
(43) Pub. Date: Jan. 31, 2008

(54) Method and system for managing network ports

(75) Inventor: Kamalaksha Venkataraman, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P.

(21) Appl. No.: 11/826,885

(22) Filed: Jul. 19, 2007

(30) Foreign Application Priority Data
Jul. 31, 2006 (IN) 1339/CHE/2006

(51) Int. Cl. H04L 12/56

(52) U.S. Cl. 370/389

(57) ABSTRACT

A method of managing a network port, comprising the steps of: a networking application requesting to listen on the network port; a networking layer opening the port for listening; and the networking layer maintaining the port open for listening if the execution of the networking application halts.

### BACKGROUND TO THE INVENTION

Popular TCP/IP networking server applications, such as a web or mail server, operate by “Listening” for incoming requests on a particular networking port and servicing those requests with appropriate responses. These server applications are typically started at system boot time. The applications can also be temporarily stopped and restarted by the system administrator. Each of the networking applications that listen on a particular port and respond to requests arriving over that port are said to be providing a service on that port.

If for some reason, such as a bug in the networking application, the application is killed by the operating system; all the networking services started by the application are automatically terminated by the system. The services become available once again when the networking application is restarted. Between the time the application is killed and is restarted, the networking service offered by the application on a particular port temporarily becomes unavailable. Any remote client that attempts to connect to this server on the port will not be able to make a connection and typically receives the message “No Listener”, which simply means that the requested service is not available on the system at this time.

When a networking application that provides a service over the network crashes due to some reason or is otherwise halted, the address and port on which the service was being provided are normally deactivated and the TCP/IP stack will no longer accept any connection requests. This can lead to unpredictable client behaviour.

### BRIEF DESCRIPTION OF THE DRAWINGS

Embodiments of the invention will now be described, by way of example only, with reference to the accompanying drawings in which:

FIG. 1: shows a diagram illustrating a typical networking application setup.

FIG. 2: shows a diagram illustrating a typical interaction with a networking application.

FIG. 3: shows a diagram illustrating the starting and killing of a networking application.

FIG. 4: shows a diagram illustrating the restarting of the networking application.

### DETAILED DESCRIPTION OF PREFERRED EMBODIMENTS

There will be described a method and apparatus that allows a networking service client over a computer network, such as the Internet, to continue to send requests and not receive any “No Listener” errors, even when the networking application on the server system is temporarily unavailable due to an application crash, or is otherwise halted.

Such an application crash could be caused, for instance, by a bug within the application, by the application electing to exit and restart due to the detection of an irrecoverable error during its course of execution, or the application could be halted by a system administrator restarting the application with new/additional parameters/configuration.

The technique will be described in relation to the TCP/IP protocols, but the technique described does not change the functionality of the TCP/IP. However, it will be appreciated by those skilled in the art that technique may be applicable to other network protocols, such as any OSI (Open System Interconnect) Layer 4 Connection Oriented Transport Service protocol, with appropriate modifications.

The technique ensures that the address and the port will remain active and that the TCP/IP stack will continue to accept incoming requests for the address and the port, and pass on these requests to the networking application when it restarts.

The result of the method is that the remote client will continue to wait until the networking application that provides the service is restarted at which time the client's requests are serviced.

The method can be provided as a feature in the networking stack. However, the TCP/IP specifications require that if there is no application providing a service on a port, the networking stack should send a “No Listener” message. Therefore, it is recommended that the method of the invention is implemented as an optional feature of the networking stack which can be turned on or off by the system administrator. This is recommended on the basis that the system administrator may use it if they find it useful or disable it if they would rather have a system that conforms to the standards. Furthermore the ability to turn the feature off allows for special situations such as, if the application that uses this feature crashes repeatedly upon restart, the system administrator can choose to have the remote clients receive a “No Listener” message instead of waiting endlessly while the problem (application not starting up correctly) is diagnosed and rectified.

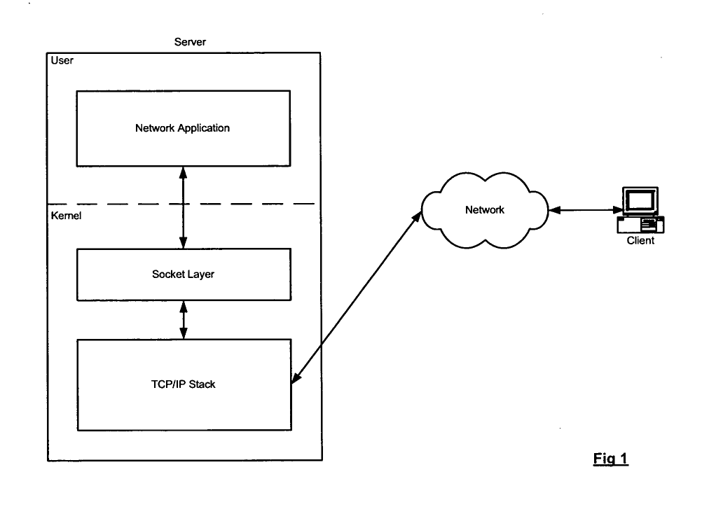

FIG. 1 shows a typical setup of a TCP/IP networking application 1 providing a service over a computer network 2 such as the Internet. The networking application 1 is executing on a server 3 connected to a network 2. A client device 4 is also connected to the network 2. The server 3 is executing a TCP/IP stack 5 to enable applications 1 to interface with the network 2. The socket layer 6 is a layer that provides access to the TCP/IP services 5 through a socket interface.

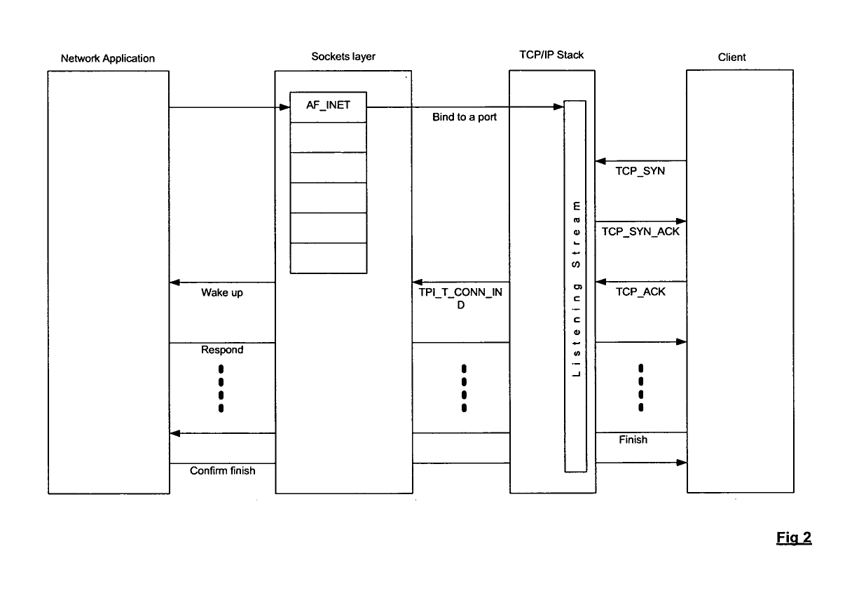

Referring to FIG. 2, a typical sequence of operations that take place for a client to receive the service from the networking application will be described.

In step 1, networking application 10 creates a listening endpoint using the following sequence:
a. Create a socket of type AF_INET/SOCK_STREAM (or AF_INET6/SOCK_STREAM).
b. Bind to an endpoint (port and address on which the service will be provided). This notifies the TCP/IP stack that any data sent to this port should be sent to the application. The TCP/IP stack consequently sets up a stream that listens for requests on the specified port and address. This stream is called the Listening Stream 9.
c. The application 10 goes to sleep and waits for an incoming connection request.

In step 2, the client initiates a connection to the networking application by sending a TCP SYN packet to the port on which the networking application is listening.

In step 3, the TCP/IP stack on the server verifies that a stream is listening for requests on this port and responds to the client with a TCP SYN-ACK packet.

In step 4, the client sends a TCP ACK packet, thus establishing the connection.

In step 5, the server sends a TPI T_CONN_IND message upstream to the socket layer.

In step 6, the socket layer wakes up the networking application, informing that there is an incoming request.

In step 7, the networking application wakes up, reads the incoming request and responds appropriately, thus providing the service to the client over the network.

When the client is finished with utilising the service the TCP/IP connection is shutdown, in step 8, by mutual consent of the server and the client.

If for some reason (such as a bug in the networking application), the application is killed by the operating system or is otherwise halted, the socket layer of this general type is normally arranged to dismantle all the listening streams set up by the networking application by issuing appropriate commands to the TCP/IP stack. Therefore under normal circumstances when the networking application dies due to some reason, the service that it was providing becomes unavailable. When it is restarted, it goes through the same process as before to register a service and cause the TCP/IP stack to set up a listening stream.

In these circumstances, while the service is unavailable, clients requesting the service will receive a “No Listener” error. Upon receiving such an error the client may do one of the following:
i) Since there is no listener, assume that the requested service is not available on this server and go to another server where the required service is offered. In essence, from a client's perspective, this is the same as a server-down situation.
ii) Retry the connection request any number of times, not knowing whether the service will ever become available. This can cause increased bandwidth usage with potentially no useful outcome.

The technique to be described below ensures that a client does not receive a “No Listener” error when it tries to connect to the networking application. This is achieved by selectively maintaining, rather than dismantling, the listening stream when the networking application is killed.

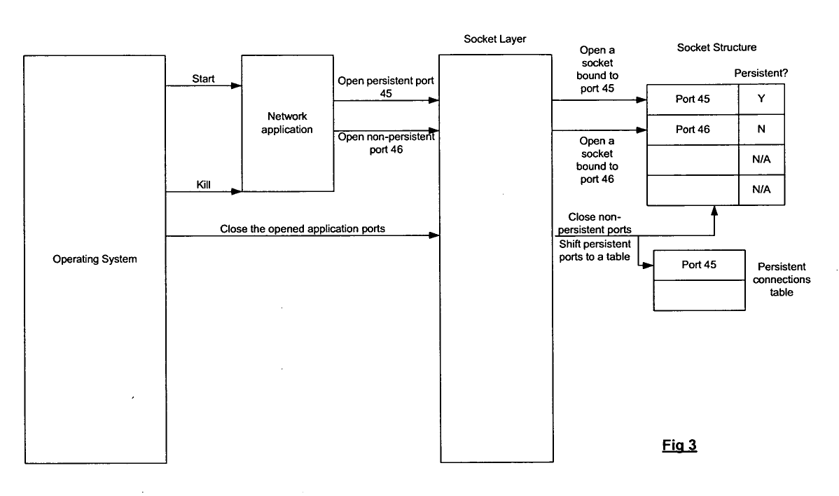

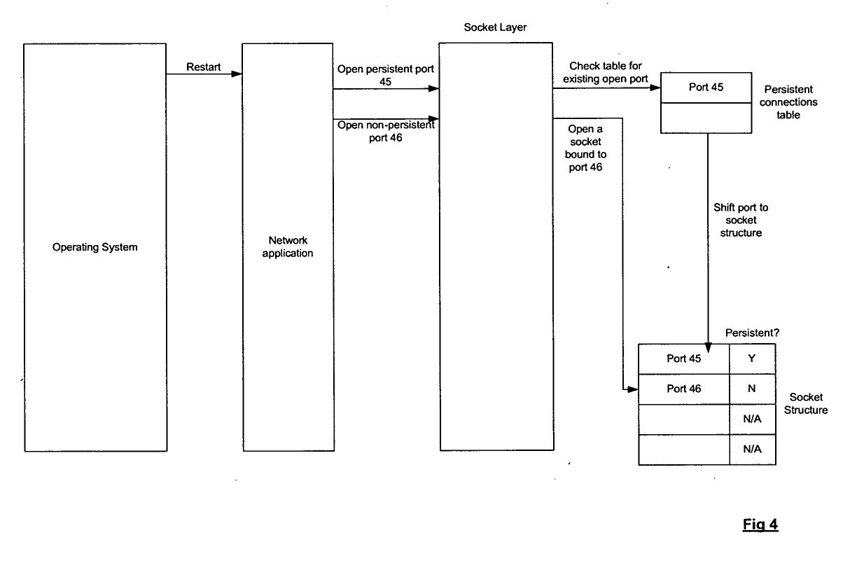

A method of operation will be described with reference to FIGS. 3 and 4.

When the networking application 13 creates a listening endpoint (such as in step 1), it also may specify to the socket layer that the newly created listening stream has to be made persistent 14. The means of doing this is specific to the operating system in which the invention is operating. In a UNIX computer system this may be done by using a suitable ioctl( ) call which is made by an application and can alter properties of a socket. The socket layer 15 then marks or flags the socket structure 16 associated with the stream as a persistent stream 17. When the operating system kills 18 the application 13, it tells the socket layer 15 to close 19 the socket associated with the listening stream in the normal way. However, the socket layer 15 looks at the associated socket structure 16 and sees that this is a persistent connection 17. Instead of dismantling the stream (as is the default case), it simply moves the socket structure into a list of persistent connections 20. Since the socket layer never informs the TCP/IP stack to dismantle the stream, the TCP/IP stack continues to accept incoming connections, as if nothing had happened, and queues the connections for servicing.

Any data for the new connection transmitted with the incoming connections are queued for servicing as well.

Referring to FIG. 4, when the application 13 restarts 21, it goes through the usual process of creating the listening endpoint (as in step 1). When the socket layer 15 receives the request to bind to an address (step 1b), it is arranged to search the list of persistent connections 20. If a match is found, the socket layer associates the old socket structure with this existing socket 22. The networking application will now proceed to service the requests that were queued up after it was killed and during restarting.

It will be appreciated that a separate module between the networking application and the socket layer could perform the above-described enhanced functionality of the socket layer. However, as this module will have to replicate significant functionality of the operating system, it is expected to be more likely that this functionality be encapsulated within the socket layer.

When the application exits normally, it will want to close the socket and dismantle the stream. The application accomplishes this by resetting the “persistent” flag 17 on the socket and closing the socket.

The technique is most effective when the administrator has made provisions to restart the application automatically when it crashes. This is a simple and trivial task on most operating systems, particularly UNIX.

In this way, the potential for unavailability of a port address between a network application crash and restart can be reduced. In consequence:
Clients don't assume that the server does not provide the requested networking service.
The cost of dropping and re-establishing the networking connection with the server is saved, thus saving network bandwidth.

There has been described a method of managing a network port, comprising the steps of: a networking application requesting to listen on the network port; a networking layer opening the port for listening; and the networking layer maintaining the port open for listening if the execution of the networking application halts.

The networking layer may receive a indication from the networking application as to whether the network port is to be persistent and mark the network port as persistent or otherwise in accordance with the indication.

When the execution of the networking application halts, the networking layer may determine whether the network port is marked as persistent and, if the network port is marked as persistent, not dismantle the network port, but rather place the network port in a storage structure for persistent connections.

If execution of the networking application resumes and the networking application requests to listen on a network port, the networking layer may search the storage structure for the network port and if the network port is found in the storage structure, the network port may be retrieved from the storage structure and associated with the socket corresponding to the request.

There has also been described apparatus for managing a network port, comprising:

a collection of open ports; a collection of flags, each flag corresponding to an open port;
wherein the status of the flag comprises persistent or non-persistent; a storage structure for storing a list of open ports with a corresponding flag with status of persistent; and
a logic unit arranged for: setting the flags on the instructions of a networking application;
opening a port on the instruction of a networking application; placing an open port in the list in the storage structure if the networking application is halted and the corresponding flag is persistent; closing an open port if the networking application is halted and the corresponding flag is non-persistent; assigning a networking application a port from the storage structure if the networking application requests a port that is already stored in the list in the storage structure.

The logic unit may be a socket layer and may be part of a TCP/IP stack.

It will be understood that the techniques described may be implemented in the form of a computer program product comprising program code elements for carrying out the above described method. The computer program product may take the form of a socket layer and/or a TCP/IP stack.

1. A method of managing a network port, comprising the steps of:
a networking application requesting to listen on the network port;
a networking layer opening the port for listening; and
the networking layer maintaining the port open for listening if the execution of the networking application halts.

2. A method as claimed in claim 1 comprising the networking layer receiving a indication from the networking application as to whether the network port is to be persistent and the networking layer marking the network port as persistent or otherwise in accordance with the indication.

3. A method as claimed in claim 2 comprising, when the execution of the networking application halts, the networking layer determining whether the network port is marked as persistent and wherein, if the network port is marked as persistent, the network port is not dismantled.

4. A method as claimed in claim 3 where if the network port os not marked as persistent when the execution of the networking application halts, the network port is dismantled.

5. A method as claimed in claim 3 comprising placing the network port in a storage structure for persistent connections.

6. A method as claimed in claim 5 wherein, if execution of the networking application resumes and the networking application requests to listen on a network port, the networking layer searches the storage structure for the network port and if the network port is found in the storage structure, the network port is retrieved from the storage structure and associated with the socket corresponding to the request.

7. A method as claimed in claim 1 wherein the network port is a TCP/IP connection.

8. Apparatus for managing a network port, comprising:
a collection of open ports;
a collection of flags, each flag corresponding to an open port; wherein the status of the flag comprises persistent or non-persistent;
a storage structure for storing a list of open ports with a corresponding flag with status of persistent; and
a logic unit arranged for:
setting the flags on the instructions of a networking application;
opening a port on the instruction of a networking application;
placing an open port in the list in the storage structure if the networking application is halted and the corresponding flag is persistent;
closing an open port if the networking application is halted and the corresponding flag is non-persistent
assigning a networking application a port from the storage structure if the networking application requests a port that is already stored in the list in the storage structure.

9. Apparatus as claimed in claim 8 wherein the logic unit is a socket layer.

10. Apparatus as claimed in claim 9 wherein the socket layer is part of a TCP/IP stack.

11. Apparatus as claimed in claim 10 wherein the logic unit is arranged for opening a port with the assistance of the TCP/IP stack.

12. A computer program product comprising program code elements for carrying out the method of claim 1.

13. A computer program product as claimed in claim 12 in the form of a socket layer.

14. A computer program product as claimed in claim 12 in the form of a TCP/IP stack.
